(19) United States
(12) Patent Application Publication
(10) Pub. No.: US 2022/0277150 A1
(43) Pub. Date: Sep. 1, 2022

(54) User Equipment, Network Node and Methods in a Communications Network

(71) Applicant: Telefonaktiebolaget LM Ericsson (publ), Stockholm (SE)

(72) Inventor: Ester Gonzalez de Langarica, Vitoria (ES)

(21) Appl. No.: 17/628,604

(22) PCT Filed: Jul. 23, 2019
(86) PCT No.: PCT/SE2019/050709

§ 371 Date: Jan. 20, 2022

(51) Int. Cl. G06F 40/58; H04L 12/18; H04L 51/02; H04W 4/16

(52) U.S. Cl. CPC G06F 40/58; H04L 12/1822; H04L 51/02; H04W 4/16

(57) ABSTRACT

A method performed by a first network node in a communications network, for handling translations of an ongoing media session between participants is provided. The first network node receives an audio input from a first UE of one of the participants in the ongoing media session, and provides at least a transcript of the audio input to the first UE and a translation of the audio input to a second UE of another participant in the ongoing media session. The first network node further obtains, from the first UE, an indication of an error in the transcript, and thereafter provides, to the second UE of the other participant in the ongoing media session, the indication of the error in the transcript.

### TECHNICAL FIELD

Embodiments herein relate to a first User Equipment (UE), a network node, a second UE, and methods therein. In particular, embodiments herein relate to handling translations in an ongoing media session.

### BACKGROUND

Over-The-Top (OTT) services have been introduced in wireless communication networks allowing a third party telecommunications service provider to provide services that are delivered across an IP network. The IP network may e.g. be a public internet or cloud services delivered via a third party access network, as opposed to a carrier's own access network. OTT may refer to a variety of services including communications, such as e.g. voice and/or messaging, content, such as e.g. TV and/or music, and cloud-based offerings, such as e.g. computing and storage.

Traditional communication networks such as e.g. Internet Protocol Multimedia Subsystem (IMS) Networks are based on explicit Session Initiation Protocol (SIP) signaling methods. The IMS network typically requires a user to invoke various communication services by using a keypad and/or screen of a user equipment (UE) such as a smart phone device. A further OTT service is a Digital Assistant (DA). The DA may perform tasks or services upon request from a user, and may be implemented in several ways.

A first way to implement the DA may be to provide the UE of the user with direct access to a network node controlled by a third party service provider comprising a DA platform. This may e.g. be done using a dedicated UE having access to the network node. This way of implementing the DA is commonly referred to as an OTT-controlled DA.

A further way to implement the DA is commonly referred to as an operator controlled DA. In an operator controlled DA, functionality such as e.g. keyword detection, request fulfillment and media handling may be contained within the domain of the operator referred to as operator domain. Thus, the operator controls the whole DA solution without the UE being impacted. A user of the UE may provide instructions, such as e.g. voice commands, to a core network node, such as e.g. an IMS node, of the operator. The voice command may e.g. be “Digital Assistant, I want a pizza”, “Digital Assistant, tell me how many devices are active right now”, “Digital Assistant, set-up a conference”, or “Digital Assistant, how much credit do I have?”. The core network node may detect a hot-word, which may also be referred to as a keyword, indicating that the user is providing instructions to the DA and may forward the instructions to a network node controlled by a third party service provider, the network node may e.g. comprise a DA platform. The DA platform may e.g. be a bot, e.g. software program, of a company providing a certain service, such as e.g. a taxi service or a food delivery service. The instructions may be forwarded to the DA platform using e.g. a Session Initiation Protocol/Real-time Transport Protocol (SIP/RTP). The DA platform may comprise certain functionality, such as e.g. Speech2Text, Identification of Intents & Entities and Control & Dispatch of Intents. The DA platform may then forward the instructions to a further network node, which may e.g. be an Application Server (AS) node, which has access to the core network node via an Application Programming Interface (API) denoted as a Service Exposure API. Thereby the DA may access the IMS node and perform services towards the core network node. The DA platform is often required to pay a fee to the operator in order to be reachable by the operator's DA users. The user may also be required to pay fees to the operator and network provider for the usage of DA services. The operator may further be required to pay fees to the network provider for every transaction performed via the Service Exposure API.

An operator controlled DA may be used in conjunction with a translation service. As mentioned above, in the operator controlled DA model, the operator has full control of the media. This enables the implementation of services such as in-call translations. In such a service, the operator may listen to the conversation in two different languages and translate every sentence said by the users. The operator listens to the conversation and translates and/or transcripts the user's audio. The written transcript and translated content may then be continuously delivered to the users in real time as audio and/or text. However, a translation service may misunderstand what is said due to e.g. background noise, a person's accent or articulation, and/or flaws in the speech recognition system. Thus, a translation may be erroneous which may lead to misunderstandings between participants in a media session.

### SUMMARY

Reliable in-call translation services that are available on demand, i.e. readily accessible to a user when he/she requires the service, are increasingly sought after. However, while using such in-call translation services, participants in a media session are unable to indicate if a translation is incorrect.

It is, therefore, an object of the embodiments herein to provide a mechanism that improves an in-call translation service e.g. in user friendliness manner and/or in a more correct manner.

According to an aspect of embodiments herein, the object is achieved by a method performed by a first network node in a communications network, for handling translations of an ongoing media session between participants. The first network node receives an audio input from a first UE of one of the participants in the ongoing media session, and provides at least a transcript of the audio input to the first UE and a translation of the audio input to a second UE of another participant in the ongoing media session. The first network node then obtains, from the first UE, an indication of an error in the transcript, and then provides, to the second UE of the other participant in the ongoing media session, the indication of the error in the transcript.

According to another aspect of embodiments herein, the object is achieved by a method performed by a first UE in a communications network, for handling translations of an ongoing media session between participants. The first UE transmits, to a first network node, an audio input from a user of the first UE and then receives, from the first network node, a transcript of the audio input, wherein the transcript is displayed to the user of the first UE. The first UE then obtains an input from the user of the first UE indicating an error in the transcript. In response to the obtained input, the first UE transmits, to the first network node, an indication of the error.

According to yet another aspect of embodiments herein, the object is achieved by a method performed by a second UE in a communications network, for handling translations of an ongoing media session between participants. The second UE receives, from a first network node, a translation of an audio input of a media session between participants. The second UE then receives, from the first network node, an indication of an error in the received translation of the media session between the participants. The indication may e.g. be the same indication as the one transmitted from the first UE.

According to a further aspect of embodiments herein, the object is achieved by a first network node configured to handle translations of an ongoing media session between participants. The first network node is further configured to receive an audio input from a first UE of one of the participants in the ongoing media session and then provide at least a transcript of the audio input to the first UE and a translation of the audio input to a second UE of another participant in the ongoing media session. The first network node is further configured to obtain, from the first UE, an indication of an error in the transcript. Having received the indication, the network node is further configured to provide, to the second UE of the other participant in the ongoing media session, the indication of the error in the transcript.

According to yet another aspect of embodiments herein, the object is achieved by a first UE configured to handle translations of an ongoing media session between participants. The first UE is further configured to transmit, to a first network node, an audio input from a user of the first UE, and receive, from the first network node, a transcript of the audio input, wherein the transcript is displayed to the user of the first UE. The first UE is further configured to obtain an input from the user of the first UE indicating an error in the transcript. In response to the obtained input, the first UE is configured to transmit, to the first network node, an indication of the error.

According to a yet further aspect of embodiments herein, the object is achieved by a second UE configured to handle translations of an ongoing media session between participants. The second UE is further configured to receive, from a first network node, a translation of an audio input of a media session between participants. The second UE is further configured to receive, from the first network node, an indication of an error in the received translation of the media session between the participants.

The performance and quality of in-call translation services may be improved according to the embodiments above, e.g. since participants may indicate when an error has occurred in the translation. Yet another advantage of embodiments herein is the provided possibility to indicate when a translation is incorrect and avoid misunderstandings. Thus, embodiments herein provide a mechanism that improves the in-call translation service e.g. in a user friendliness manner and/or in a more correct manner

### BRIEF DESCRIPTION OF THE DRAWINGS

Examples of embodiments herein are described in more detail with reference to attached drawings in which:

FIG. 1 is a schematic diagram illustrating an operator controlled DA.

FIG. 2 is a schematic diagram illustrating embodiments of a communications network.

FIG. 3 is a schematic overview depicting embodiments of user interfaces of UEs according to embodiments herein.

FIG. 4 is a combined flowchart and signaling scheme according to embodiments herein.

FIG. 5 is a flowchart depicting a method performed by a first UE according to embodiments herein.

FIG. 6 is a flowchart depicting a method performed by a network node according to embodiments herein.

FIG. 7 is a flowchart depicting a method performed by a second UE according to embodiments herein.

FIG. 8 is a block diagram depicting a network node according to embodiments herein.

FIG. 9 is a block diagram depicting a first UE according to embodiments herein.

FIG. 10 is a block diagram depicting a second UE according to embodiments herein.

FIG. 11 schematically illustrates a telecommunications network connected via an intermediate network to a host computer.

FIG. 12 is a generalized block diagram of a host computer communicating via a base station with a user equipment over a partially wireless connection.

FIGS. 13-16 are flowcharts illustrating methods implemented in a communication system including a host computer, a base station and a UE.

### DETAILED DESCRIPTION

Embodiments herein relate to solutions where there is exposure from the IMS network to share a user's DA with other participants in a media session. For example, a media session such as a conferencing session may be set up. In such a scenario, an operator controlled DA may activate a translation service, upon request from any of the participants in the media session.

As mentioned above, a translation service may misunderstand what is said in a media session and thereby inadvertently generate an incorrect translation. Therefore, embodiments herein provide a mechanism that lets the user of a UE see what the DA interprets by delivering a transcript, also referred to as transcription, of the audio uptake to the user. The transcript and/or a translated content may be delivered to the user in several ways, such as e.g. via messaging to the UE of each user or published on a web page displayed for the user, where users may see both the transcript and the associated translation.

Furthermore, embodiments herein provide a mechanism that relates to informing the system that a transcribed sentence is not correct, as interpreted by the Digital Assistant. If the DA transcribes a sentence incorrectly, that is an indication that the translation is also incorrect. Thus, by observing a faulty transcript, the participants are alerted to a translation error in the translation. Thus, participants in the media session may indicate a translation error in the translation to the system.

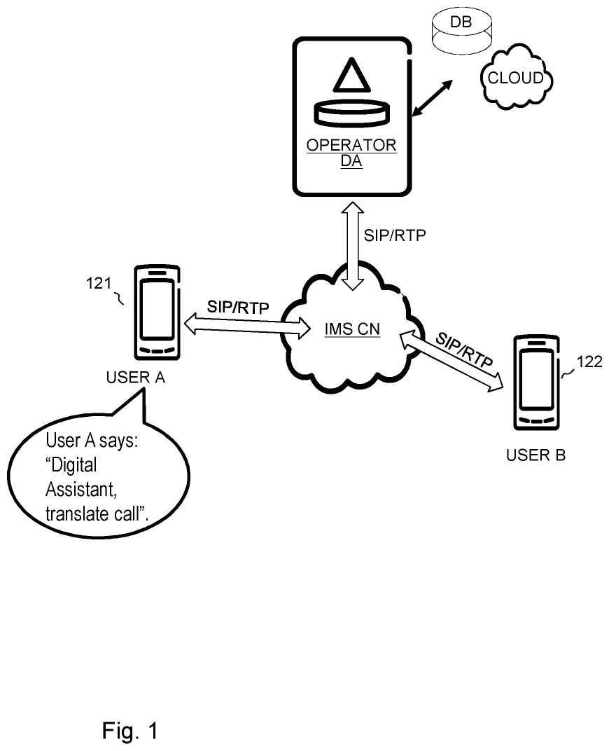

FIG. 1 depicts the fundamentals of an operator controlled DA. In FIG. 1, a first and a second user, user A and user B, are connected, via UEs, to an operator controlled DA platform node via an IMS CN. The communication between the UEs may be performed with Voice over IP (VoIP) communication, using e.g. Session Initiation Protocol (SIP) and/or Real Time Protocol (RTP) signaling methods. The DA platform node may in turn be connected to network nodes in a third party domain, such as databases and cloud based services. Any user involved in a media session, e.g. both the user A and the user B as depicted in FIG. 1, may engage an in-call service, such as a translation service, through the use of the operator controlled DA. The user A may in such a scenario e.g. say “Operator, translate this call”, and the operator controlled DA may then, in response to the spoken words, activate an in-call translation service which may e.g. be provided via a translation service of an application server in e.g. a cloud based communication network architecture. The user A and the user B may each be associated with a respective UE: a first UE 121 of the user A and a second UE 122 of the user B. Each UE provides an interface so that the respective user can convey information to the operator controlled DA and to one or more other participants in the media session.

In a scenario when the operator controlled DA has been engaged to activate an in-call translation service, the operator controlled DA is in full control of the media in the media session and, accordingly, of the transcripts and translations that are taking place during the course of the media session. The translation service may be deactivated, via the operator controlled DA, at any time by any of the participants in the media session.

As described above, a problem with in-call translation services may be that the audio input is flawed. Therefore, the interface on the respective UE of the participants in the media session displays transcripts of the audio input in order for the user of the respective UE to be able to see if an audio input, e.g. a spoken sentence, has been correctly captured by the operator controlled DA. Thus, it may be useful for the user A and the user B depicted in FIG. 1 to each receive a transcript of the audio input in the media session to their respective UE.

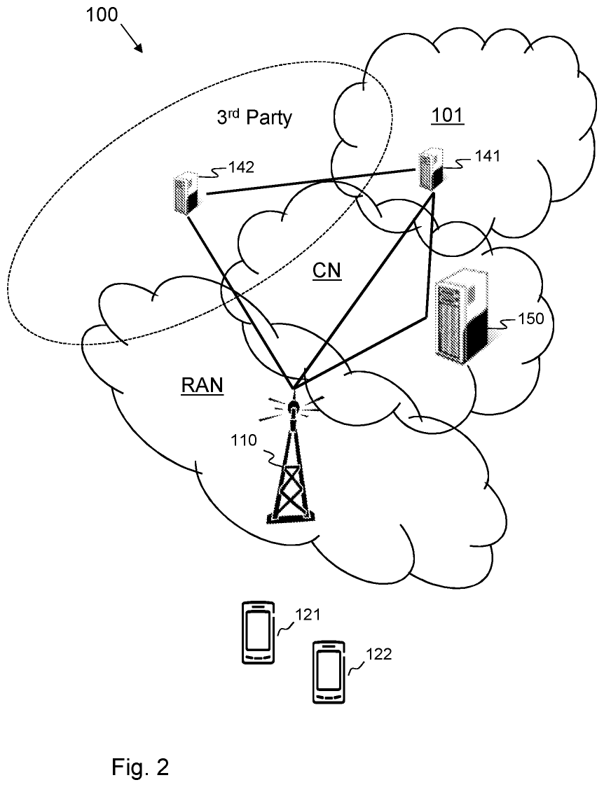

FIG. 2 is a schematic overview depicting a communications network 100 wherein embodiments herein may be implemented. The communications network 100 comprises one or more RANs and one or more CNs. The communications network 100 may use any technology such as 5G new radio (NR) but may further use a number of other different technologies, such as, Wi-Fi, long term evolution (LTE), LTE-Advanced, wideband code division multiple access (WCDMA), global system for mobile communications/enhanced data rate for GSM evolution (GSM/EDGE), worldwide interoperability for microwave access (WMax), or ultra-mobile broadband (UMB), just to mention a few possible implementations.

Network nodes operate in the communications network 100. Such a network node may be a cloud based server or an application server providing processing capacity for, e.g. managing a DA, handling conferencing, and handling translations in an ongoing media session between participants. The network nodes may e.g. comprise a first network node 141, a second network node 142, and an IMS node 150. The IMS node 150 is a node in an IMS network, which may e.g. be used for handling communication services such as high definition (HD) voice e.g. voice over LTE (VoLTE), W-Fi calling, enriched messaging, enriched calling with pre-call info, video calling, HD video conferencing and web communication. The IMS node 150 may e.g. be comprised in the CN. The IMS node may comprise numerous functionalities, such as a Virtual Media Resource Function (vMRF) for Network Functions Virtualization (NFV).

The IMS node 150 may be connected to the first network node 141. The first network node 141 may e.g. be represented by an Application Server (AS) node or a DA platform node. The first network node 141 is located in the communications network e.g. in a cloud 101 based architecture as depicted in FIG. 2, in the CN, and/or in a third party domain of the communications network 100. The third party domain may be a network node controlled by a third party service provider or an IP network such as a public internet or various cloud services delivered via a third party access network, as opposed to a carrier's own access network The first network node 141 may act as a gateway to the second network node 142, which may e.g. be represented by an Application Server (AS) node or a platform node, located in the cloud 101 or in a Third Party domain of the communications network 100. Furthermore, the IMS node 150, the first network node 141 and the second network node 142 may be collocated nodes, stand-alone nodes or distributed nodes comprised fully or partly in the cloud 101. The second network node 142 may be a network node in a third party network or domain.

The communications network 100 may further comprise one or more radio network nodes 110 providing radio coverage over a respective geographical area by means of antennas or similar. The geographical area may be referred to as a cell, a service area, beam or a group of beams. The radio network node 110 may be a transmission and reception point e.g. a radio access network node such as a base station, e.g. a radio base station such as a NodeB, an evolved Node B (eNB, eNode B), an NR NodeB (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Mobile device to Mobile device (D2D) communication, or any other network unit capable of communicating with a UE within the cell served by the radio network node 110 depending e.g. on the radio access technology and terminology used.

UEs such as the first UE 121 of user A and the second UE 122 of user B operate in the communications network 100. The respective UE may e.g. be a mobile station, a non-access point (non-AP) station (STA), a STA, a user equipment (UE) and/or a wireless terminals, an narrowband (NB)-internet of things (IoT) mobile device, a Wi-Fi mobile device, an LTE mobile device and an NR mobile device communicate via one or more Access Networks (AN), e.g. RAN, to one or more core networks (CN). It should be understood by those skilled in the art that “UE” is a non-limiting term which means any terminal, wireless communication terminal, wireless mobile device, device to device (D2D) terminal, or node e.g. smart phone, laptop, mobile phone, sensor, relay, mobile tablets, television units or even a small base station communicating within a cell.

It should be noted that although terminology from 3GPP LTE has been used in this disclosure to exemplify the embodiments herein, this should not be seen as limiting the scope of the embodiments herein to only the aforementioned system. Other wireless or wireline systems, including WCDMA, WiMax, UMB, GSM network, any 3GPP cellular network or any cellular network or system, may also benefit from exploiting the ideas covered within this disclosure.

Embodiments herein provide a mechanism that improves the in-call translation service e.g. in a user friendliness manner and/or in a more correct manner by letting participants such as the user A or the user B indicate when an error has occurred in a translation of a media session between the participants.

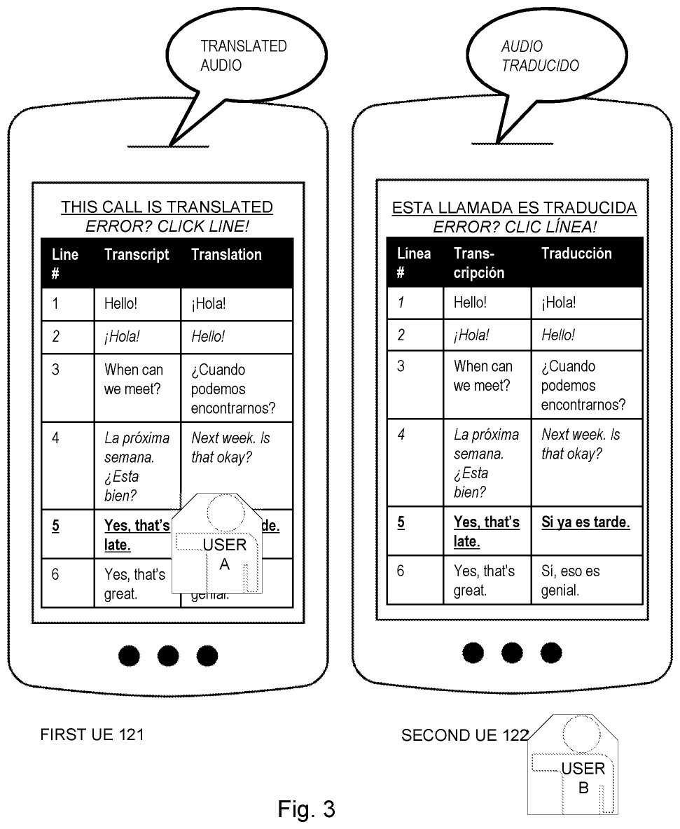

An example of embodiments herein is depicted in FIG. 3 and will be explained by means of the following example scenario.

In the example in FIG. 3, two users, denoted as user A and user B, are engaged in a media session, such as a conference call. The user A is associated with the first UE 121 and the user B is associated with the second UE 122, i.e. each user uses a respective UE for the conference call. The user A speaks a different language than user B and the users are therefore using an in-call translation service provide by the communication network 100. In the media session there are thus two languages: an original language that respective user uses, and a designated language, which is a language into which audio input should be translated. In addition to a translated audio, the in-call translation service also provides a written transcript for everything that is said in the media session. This means that when a user in the media session says something, i.e. provides audio input, the audio input will be transcribed and translated. The transcribed audio is provided as transcripts to one or more participants in the media session e.g. in both the original language and the designated language. Thereby, the user who has spoken, i.e. whose audio uptake has generated the transcript, will be able to see if the transcript correctly reflects what was said. If the transcript in the original language is correct, the translated transcript and the translated audio input is assumed to be correct as well. Since the users speak different languages, they have no way of knowing if the translation is correct. Through the provision of the transcript however, they are given a possibility to react if what they said has not been correctly transcribed and thus not correctly translated.

This process may be illustrated by means of the example in FIG. 3. In the example it is assumed that the user A speaks English and the user B speaks Spanish. Furthermore, it is assumed that the in-call translation service has been started, e.g. through a voice command from at least one of the user A and the user B. Such a voice command may be given to an operator controlled DA by the user A and/or the user B, for example by saying “Operator, start translating”.

The user A begins the conversation and says “Hello” using the first UE 121. The translation service of the communication network may pick up the audio input and:
1. transcribe the audio input into a transcript of the original language (i.e. English);
2. translate the transcript into a transcript in the designated language (i.e. Spanish); and
3. translate the transcript in the designated language into an audio output in the designated language (i.e. Spanish).

Both the original and designated language transcripts may be provided to both the user A, via the first UE 121, and to the user B, via the second UE 122. In the example in FIG. 3, the transcripts are displayed on-screen to the respective user. As may be seen on the illustrated screens of the respective UE, both users, i.e. the user A and the user B, are provided with transcripts in English and Spanish.

In line 1, the user A has said “Hello”, which was correctly picked up by the translation service and transcribed in English and Spanish and provided as audio in Spanish to the user B. In FIG. 3, lines from the user B are italicized. It can thus be seen that user B answers “!Hola!” (line 2) when the user A says “Hello!” (line 1). Thereafter, the user A says “When can we meet?” (line 3) and the user B answers “La próxima semana. ¿Esta bien?” (line 4).

The users A and B may speak to each other in a normal fashion and follow the transcripts to make sure that what they say is picked up correctly. The user A may detect that when he/she says “Yes, that's great”, the audio input has incorrectly been interpreted as “Yes, that's late”, as shown in the transcript of line 5. The user A notices this mistake since the transcript does not correspond to what was said. The user A wants to alert the user B to the fact that there's been a mistake, so as to avoid a misunderstanding. Thus, in order to provide an indication of an error in the transcript, which will generate an incorrect translation, to the user B, the user A may e.g. click the incorrect line, i.e. line 5. The line 5 may then immediately change its appearance, so that it draws the attention of the user B in particular. The change in appearance may also be useful to the user A since the user A then knows that the error indication was properly registered. In the example in FIG. 3, the text has become bold and underlined in response to a touch command given by the user A. Other options are of course possible as well, such as color or font change, or the appearance of a flag or other icon.

The indication of error provided by the user A of the first UE 121 may be given in other ways than through a touch command, i.e. clicking on the first UE 121. For example, in a hands-free scenario, the user A may indicate an error in the transcript by means of a voice command to the DA via the first UE 121. The user A may for example say “Operator, error in line 5”. The keyword “operator” may alert the DA and the intent “error in line 5” may prompt the DA to ensure that the indicated line is marked as erroneous.

When the user B sees that the line 5 has been indicated as comprising an error, the user B may wait to respond so that the user A has a chance to speak again and generate a successful translation. Another option for the user B may be to ask the user A to repeat what the user A just said. In the example in FIG. 3, the user B may wait and the user A may then provide the same sentence again. This time, the audio input from the user A, i.e. “yes, that's great”, has been picked up correctly and, consequently, the transcript and the translation are correct as disclosed in line 6.

The user A and the user B may continue their conversation thusly, and when they are finished, either of the users may end the in-call translation service. The in-call translation service may, e.g., be terminated through a voice command to the operator controlled DA. In such a scenario, either of the users may, e.g., say “Operator, stop translating”.

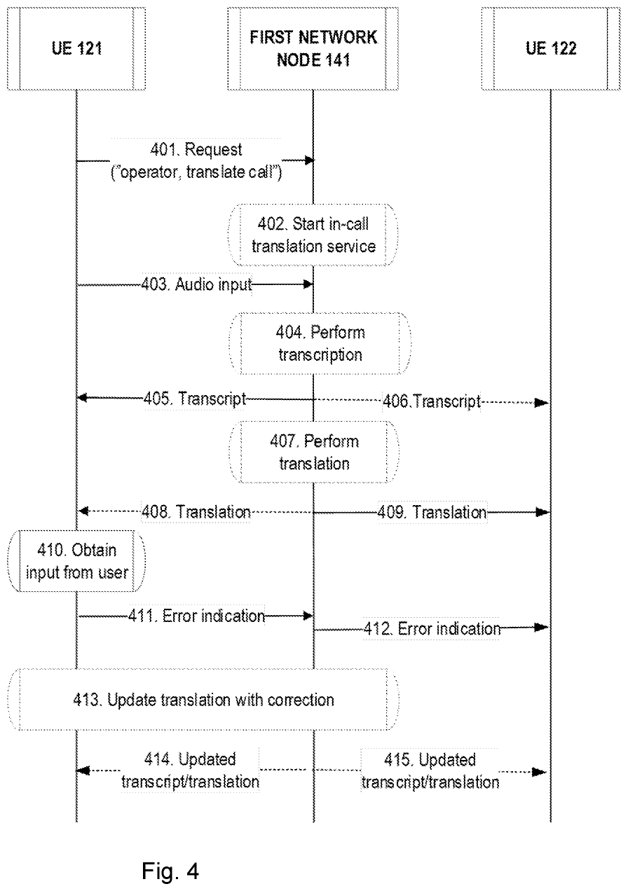

Another example of embodiments herein is depicted in FIG. 4 and will be explained by means of the following example scenario.

In the example scenario in FIG. 4, the first UE 121 and the second UE 122 are connected to the first network node 141. The first UE 121 and the second UE 122 may be connected to the first network node 141 via the IMS node 150 in the CN, as illustrated in FIGS. 1 and 2. The first UE 121 and the second UE 122 are associated with the user A and the user B respectively, i.e. the first UE 121 is associated with the user A, and the second UE 122 is associated with the user B. The two users, A and B, are engaged as participants in a media session, such as a conference call. An operator controlled DA comprised in the first network node 141 listens to the media session and may be alerted when any of the participants speaks a pre-defined keyword, which may also be referred to as a hot-word.

Action 401. In the example scenario in FIG. 4, while engaged as a participant in the media session, the user A says “Operator, translate the call”. The operator controlled DA is alerted, through the use of the keyword “operator”. Thus, the request is sent from the first UE 121 to the first network node 141 to start the in-call translation.

Action 402. The first network node 141, such as the DA, is familiar with the request “translate the call” and will, therefore, upon request from any participant in the media session, start an in-call translation service when such a request is made.

Action 403. When the first network node 141 has ensured an initiation of the in-call translation service, the audio input from the participants in the media session may be translated. In the example depicted in FIG. 4, the user A speaks, which is picked up by the microphone in the first UE 121 as an audio input. The first UE 121 then transmits the audio input to the first network node 141. This Action relates to Actions 501 and 601 respectively, described below.

Action 404. The first network node 141 may subsequently perform the first part of the in-call translation service, i.e. transcribe the audio input.

Action 405. In the example, the audio input from the user A is transcribed into the transcript and the transcript is provided to the first UE 121, where the transcript is displayed to the user A. This Action relates to Actions 502 and 602, described below.

Action 406. Optionally, the transcript may also be provided to all other participants in the media session. In the example scenario that means the first network node 141 would provide the transcript to the second UE 122, where it may be displayed to the user B.

Action 407. In the example in FIG. 4, the first network node 141 also performs a translation. In FIG. 4, the translation is performed based on the transcript, i.e. the first network node 141 first transcribes the audio input and then translates the transcript. Thus, the translation is based on the transcript. It should be noted that the request may also be forwarded to the second network node 142 which may fully or partly perform the transcription and/or the translation. As mentioned above, the second network node 142 may provide a transcription and/or translation service and be located in a Third Party domain.

Action 408. Having translated the audio input, e.g. by means of translating the transcription, the first network node 141 provides the translation of the audio input from the user A to the second UE 122, where it is provided to the user B. This Action relates to Actions 502 and 701, described below.

Action 409. Optionally, the translation may also be provided to one or more other participants in the media session. In the example scenario that means the first network node 141 may provide a translation to the first UE 121, where it may be accessed by the user A. This Action relates to Actions 503 and 603, described below.

Action 410. In the scenario depicted in FIG. 4, the first UE 121 obtains the indication of error such as an input from the user A. The user A may e.g. have detected an error in the transcript and thus wants to indicate that there is most likely an error in the translation provided to the user B. As exemplified above, in relation to FIG. 3, the user A wants to avert a misunderstanding in the media session and can do so by providing the input to the first UE 121. This Action relates to Action 604, described below. The input may be an indication given by a touch command such as clicking on the screen of the first UE 121, or by a voice command, as explained above relating to the example in FIG. 3. Other special purpose solutions, such as eye control and the like, may also be contemplated depending on the needs of the user of the UE. In applicable scenarios, the input may comprise a text input, such as a new transcript. Such a scenario implies that at least one user has access to appropriate technical equipment, such as a keyboard of the first UE 121. In a larger conference for example, a secretary or prompter may be charged with keeping track of the transcripts in the in-call translation. Providing an input to a UE, e.g. by clicking on a screen to indicate an error and then typing a new translation, is easier than engaging in live-transcription. Therefore, the presence of a participant with specialized transcribing skills may not be necessary. Such a facilitation may e.g. lead to cost reductions in an enterprise.

Action 411. Having received the input from the user A, the first UE 121 transmits, to the first network node 141, the indication of the error of the transcript to the first network node 141. The indication may be referred to as error indication. This Action relates to Actions 504 and 605 respectively, described below.

Action 412. When the first network node 141 has received the indication, the first network node 141 provides the indication to one or more participants in the media session. In the example in FIG. 4, this means that the indication is received by the second UE 122. Through the user interface the indication becomes noticeable to the user B, who is thereby informed that a translation error has occurred. This Action relates to Actions 505 and 702, described below. As mentioned above with reference to the example scenario in FIG. 3, it may also be suitable that the indication is clearly displayed on the first UE 121, so that the user A clearly sees that his/her input has been duly registered. However, displaying the indication may be performed internally in the first UE 121 and does not necessarily imply any signaling with the first network node 141, e.g. if the input from the user A is given as a touch command on the first UE 121. If the input from the user A is given as a voice command, however, the voice command must be provided to the DA comprised in the first network node 141, and subsequently provided from the network node 141 to the first UE 121.

Action 413. In certain applicable scenarios, the first network node 141 may update the incorrect transcript and translation with an updated version. Ideally, in such a scenario, the updated version of the transcript and translation correctly reflects the content of the audio input in the media session. Such an updated translation may be obtained from the user A, e.g. if the user A has access to a keyboard or similar equipment and provides a correct transcript, as mentioned above. The updated translation may also be provided by a machine translation service. A translation service may, e.g., be aware of certain errors that are common in an in-call translation context, such as puns or certain words that are easily confounded, for example if they sound similar when spoken. In the example above, relating to FIG. 3, it may be contemplated that a translation service is aware that if an audio input perceived as “late” has been marked as a mistake, then the intended word is often “great”. In such a scenario, when prompted to try again, the translation service may replace the word “late” with “great”, and thereby render the translation correct, simply by means of a qualified prediction. A machine learning approach may be employed to improve such predictions on behalf of a transcription and/or translation service. The transcript and/or translation service may e.g. be given a certain number of tries, such as for example only giving new examples the first two times a line is clicked on the UE. Furthermore, if only one word has been picked up incorrectly, the user may be given an option to indicate to the first network node 141 to change just that word by e.g. saying “DA, wrong word late—right word great”, where the expressions “wrong word” and “right word” would be the keywords to the first network node 141.

Action 414. If an updated transcript and translation has been attained, the first network node 141 may then provide the updated transcript and translation to the first UE 121. This Action relates to Actions 506 and 606, described below.

Action 415. If an updated transcript and translation has been attained, the first network node 141 may then provide the updated transcript and translation to the second UE 122. The participants in the media session may thereby access the updated transcript and translation. This Action relates to Actions 506 and 703, described below.

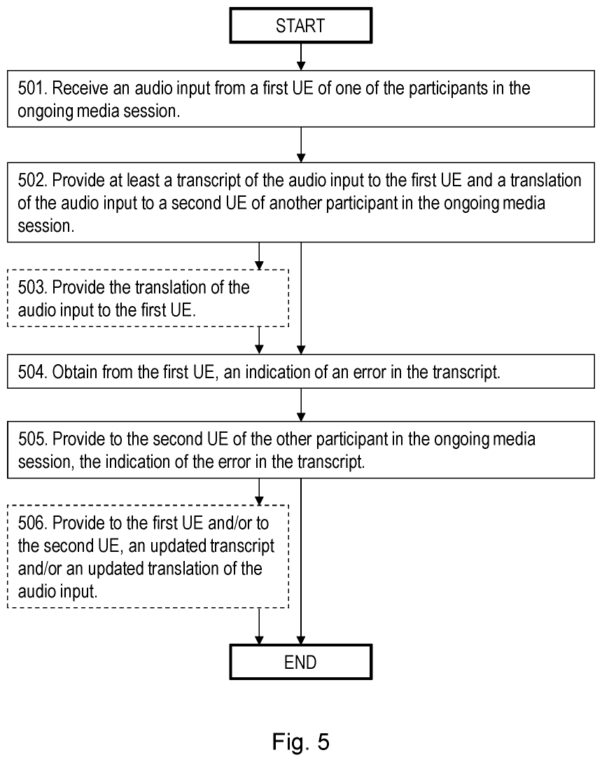

Example embodiments of, the method performed by the first network node 141 in the communications network 100, for handling translations of an ongoing media session between participants, will now be described with reference to a flowchart depicted in FIG. 5.

The method comprises the following actions, which actions may be taken in any suitable order. Actions that are optional are presented in dashed boxes in FIG. 5.

Action 501. The first network node 141 receives, the audio input from the first UE 121 of one of the participants in the ongoing media session. This Action relates to Action 403 described above and Action 601 described below.

Action 502. The first network node 141 provides at least the transcript of the audio input to the first UE 121 and the translation of the audio input to the second UE 122 of another participant in the ongoing media session. The transcript and/or the translation may be provided to the first UE 121 and/or to the second UE 122 as one or more audio parts and/or one or more text lines. This Action relates to Actions 404, 405 and 408 described above and Actions 602 and 701 described below.

Action 503. The first network node 141 may provide the translation of the audio input to the first UE 121. This Action relates to Action 407 described above and Action 603 described below.

Action 504. The first network node 141 obtains, from the first UE 121, the indication of an error in the transcript. This Action relates to Action 410 described above and Action 605 described below. The indication of the error in the transcript may comprise a voice command or a text command.

Action 505. The first network node 141 provides, to the second UE 122 of the other participant in the ongoing media session, the indication of the error in the transcript. This Action relates to Action 411 described above and Action 702 described below.

Action 506. The first network node 141 may provide, to the first UE 121 and/or to the second UE 122, the updated transcript and/or the updated translation of the audio input. This Action relates to Action 413 and 414 described above and Actions 606 and 703, respectively, described below. The updated transcript and/or updated translation of the audio input provided to the first UE 121 and/or to the second UE 122 may comprise the translation from the translation service in the second network node 142 in the communications network 100.

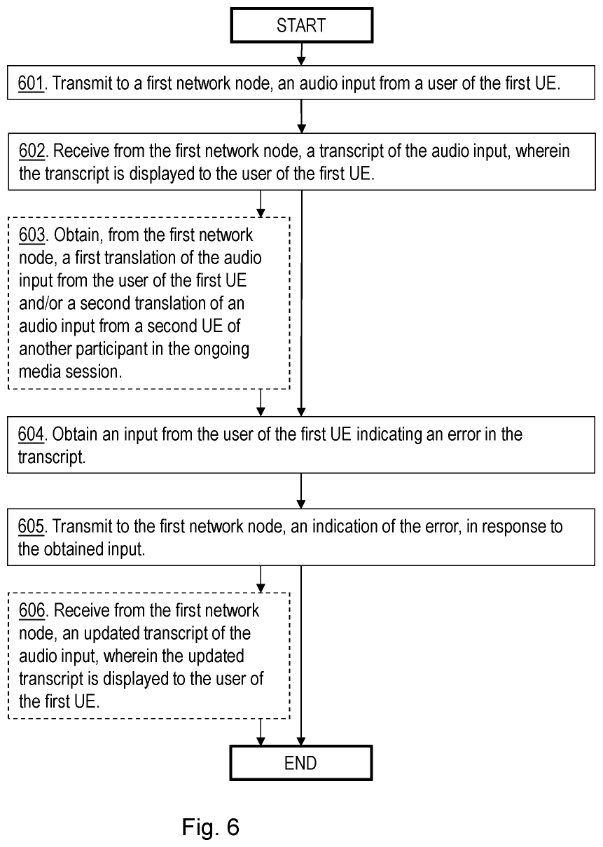

Example embodiments of the method performed by the first UE 121 in the communications network 100, for handling translations of an ongoing media session between participants, will now be described with reference to a flowchart depicted in FIG. 6.

The method comprises the following actions, which actions may be taken in any suitable order. Actions that are optional are presented in dashed boxes in FIG. 6.

Action 601. The first UE 121 transmits, to the first network node 141, the audio input from the user of the first UE 121. This Action relates to Actions 403 and 501 described above.

Action 602. The first UE 121 receives, from the first network node 141, the transcript of the audio input, wherein the transcript is displayed to the user of the first UE 121. This Action relates to Actions 404 and 502 described above. The transcript may be received as one or more text lines.

Action 603. According to some embodiments, the first UE 121 may further obtain, from the first network node 141, a first translation of the audio input from the user of the first UE 121 and/or a second translation of the audio input from the second UE 122 of another participant in the ongoing media session. The first translation, when mentioned here, is a translation of the audio input from the user of the UE 121 into the designated language. This means that the user of the UE 121 may be provided a translation of what was just said by the user of the UE 121, but in a different language. This first translation is an example of the translation referred to in Action 502 above and Action 701 below, which is provided by the first network node 12 to the second UE 122. The second translation, when mentioned here, refers to a translation of an audio input from the user of the second UE 122, translated and provided to the user of the first UE 121. This second translation is thus a translation of the audio input which is from the translation referred to in Action 502 above. This Action relates to Actions 407 and 503 described above. The first and/or second translation may be received as one or more audio parts and/or one or more text lines.

Action 604. The first UE 121 obtains the input from the user of the first UE 121 indicating an error in the transcript. This Action relates to Actions 409 described above. The input from the user of the first UE 121 may comprise one or more of the following: a voice command, or a touch command. The input from the user of the first UE 121 may comprise a text input.

Action 605. The first UE 121 transmits, to the first network node 141, the indication of the error. This Action relates to Actions 410 and 504 described above.

Action 606. According to some embodiments, the first UE 121 may further receive, from the first network node 141, the updated transcript of the audio input, wherein the updated transcript is displayed to the user of the first UE 121. This Action relates to Actions 413 and 506 described above.

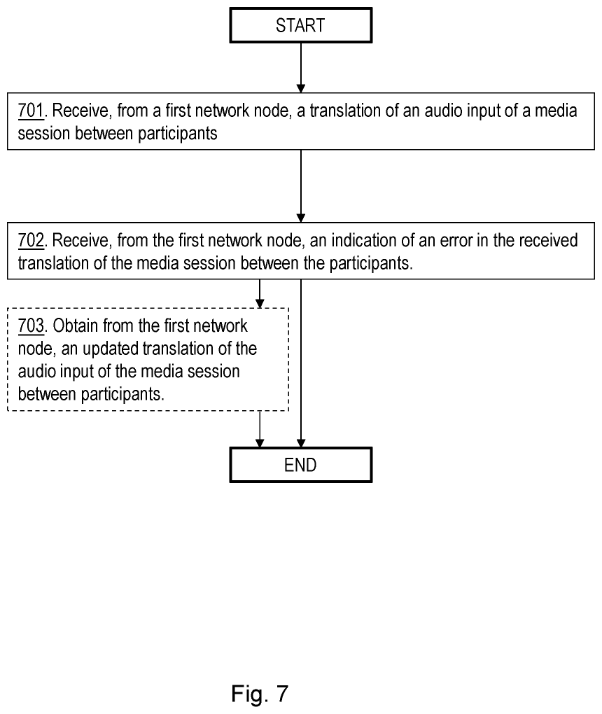

Example embodiments of the method performed by the second UE 122 in the communications network 100, for handling translations of an ongoing media session between participants, will now be described with reference to a flowchart depicted in FIG. 7.

The method comprises the following actions, which actions may be taken in any suitable order. Actions that are optional are presented in dashed boxes in FIG. 7.

Action 701. The second UE 122 receives, from the first network node 141, the translation of an audio input of a media session between participants. This Action relates to Action 407 and 502 described above. The translation may be received as one or more audio parts and/or one or more text lines.

Action 702. The second UE 122 receives, from the first network node 141, an indication of an error in the received translation of the media session between the participants. This Action relates to Actions 411 and 505 described above. The indication may be displayed to the user of the second UE 122, e.g. through the user interface of the second UE 122. As mentioned above in reference to the example in FIG. 3, the indication from the first UE 121 may result in a change in appearance of an indicated incorrect line. The text may for example change style or color, or be marked by an icon such as a flag or the like.

Action 703. According to some embodiments, the second UE 122 may further obtain, from the first network node, the updated translation of the audio input of the media session between participants. This Action relates to Actions 414 and 506 described above.

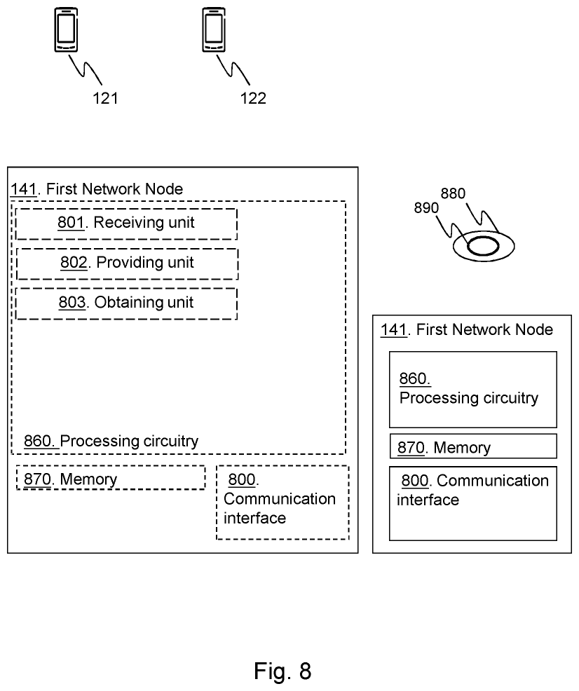

To perform the method actions above for handling translations of an ongoing media session between participants, the first network node 141 may comprise the arrangement depicted in FIG. 8.

FIG. 8 is a block diagram depicting the first network node 141 in two embodiments e.g. in the communications network 100, wherein the communications network 100 comprises the first UE 121 and the second UE 122. The first network node 141 may be used for handling translations of an ongoing media session between participants, e.g. providing indications to the first UE 121 and the second UE 122 in the communications network 100. The first network node 141 may comprise a processing circuitry 860 e.g. one or more processors, configured to perform the methods herein.

The first network node 141 may comprise a communication interface 800 depicted in FIG. 8, configured to communicate e.g. with the first UE 121 and the second UE 122. The communication interface 800 may comprise a transceiver, a receiver, a transmitter, and/or one or more antennas.

The first network node 141 may comprise a receiving unit 801, e.g. a receiver, transceiver or retrieving module. The first network node 141, the processing circuitry 860, and/or the receiving unit 801 is configured to receive the audio input from the first UE 121 of one of the participants in the ongoing media session.

The first network node 141 may comprise a providing unit 802, e.g. a transmitter, transceiver or providing module. The first network node 141, the processing circuitry 860, and/or the providing unit 802 is configured to provide at least the transcript of the audio input to the first UE 121 and the translation of the audio input to the second UE 122 of another participant in the ongoing media session. The transcript and/or the translation may be adapted to be provided to the first UE 121 and/or to the second UE 122 as one or more audio parts and/or one or more text lines. The first network node 141, the processing circuitry 860, and/or the providing unit 802 may further be configured to provide, the translation of the audio input to the first UE 121. The first network node 141, the processing circuitry 860, and/or the providing unit 802 may further be configured to provide, to the first UE 121 and/or to the second UE 122, the updated transcript and/or an updated translation of the audio input. The updated transcript and/or the updated translation of the audio input provided to the first UE 121 and/or to the second UE 122 may be adapted to comprise the translation from the translation service in the second network node 142 in the communications network 100.

The first network node 141 may comprise an obtaining unit 803, e.g. a receiver, transceiver or obtaining module. The first network node 141, the processing circuitry 860, and/or the obtaining unit 803 is configured to obtain, from the first UE 121, the indication of the error in the transcript. The indication of the error in the transcript may comprise a voice command or a text command. The first network node 141, the processing circuitry 860, and/or the providing unit 802 is further configured to provide, to the second UE 122 of the other participant in the ongoing media session, the indication of the error in the transcript.

The first network node 141 further comprises a memory 870. The memory comprises one or more units to be used to store data on, such as transcripts, audio input, indications, translations and/or applications to perform the methods disclosed herein when being executed, and similar.

The methods according to the embodiments described herein for the first network node 141 are implemented by means of e.g. a computer program product 880 or a computer program, comprising instructions, i.e., software code portions, which, when executed on at least one processor, cause the at least one processor to carry out the actions described herein, as performed by the first network node 141. The computer program 880 may be stored on a computer-readable storage medium 890, e.g. a disc, a universal serial bus (USB) stick or similar. The computer-readable storage medium 890, having stored thereon the computer program product, may comprise the instructions which, when executed on at least one processor, cause the at least one processor to carry out the actions described herein, as performed by the first network node 141. In some embodiments, the computer-readable storage medium may be a non-transitory computer-readable storage medium.

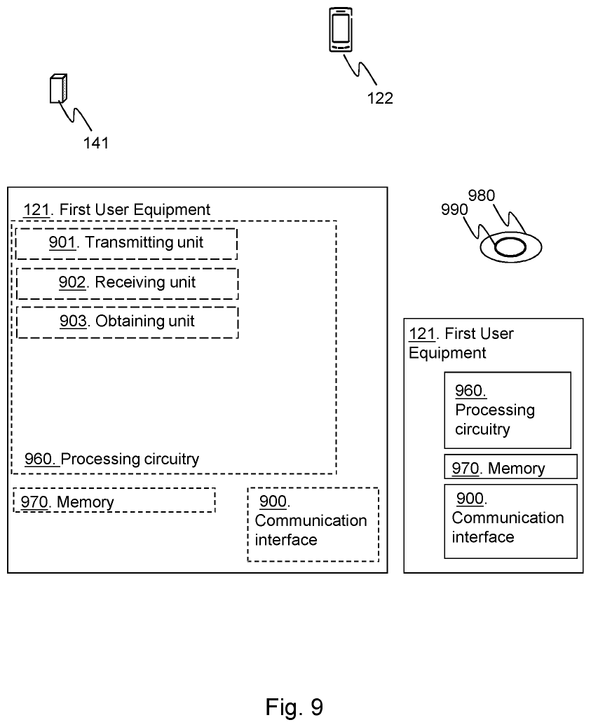

To perform the method actions above for handling translations of an ongoing media session between participants, the first UE 121 may comprise the arrangement depicted in FIG. 9.

FIG. 9 is a block diagram depicting the first UE 121 in two embodiments. The first UE 121 may be used for handling translations of an ongoing media session between participants, e.g. providing indications to the first network node 141 in the communications network 100. This first UE 121 may comprise a processing circuitry 960 e.g. one or more processors, configured to perform the methods herein.

The first UE 121 may comprise a communication interface 900 depicted in FIG. 9, configured to communicate e.g. with the second UE 122 and the first network node 141. The communication interface 900 may comprise a transceiver, a receiver, a transmitter, and/or one or more antennas.

The first UE 121 may comprise a transmitting unit 901, e.g. a transmitter, transceiver or providing module. The first UE 121, the processing circuitry 960, and/or the transmitting unit 901 is configured to transmit, to the first network node 141, the audio input from the user of the first UE 121.

The first UE 121 may comprise a receiving unit 902, e.g. a receiver, transceiver or retrieving module. The first UE 121, the processing circuitry 960, and/or the receiving unit 902 is configured to receive, from the first network node 141, the transcript of the audio input, wherein the transcript is displayed to the user of the first UE 121. The transcript may be adapted to be received as one or more text lines.

The first UE 121 may comprise an obtaining unit 903, e.g. a receiver, transceiver or retrieving module. The first UE 121, the processing circuitry 960, and/or the obtaining unit 903 may be configured to obtain from the first network node 141, the first translation of the audio input from the user of the first UE 121 and/or the second translation of an audio input from the second UE 122 of another participant in the ongoing media session. The first and/or second translation may be adapted to be received as one or more audio parts and/or one or more text lines.

The first UE 121, the processing circuitry 960, and/or the obtaining unit 903 is configured to obtain the input from the user of the first UE 121 indicating the error in the transcript. The input from the user of the first UE 121 may comprise one or more of the following: a voice command, or a touch command. The input from the user of the first UE 121 may comprise a text input. The first UE 121, the processing circuitry 960, and/or the transmitting unit 901 is further configured to, in response to the obtained input, transmit, to the first network node 141, the indication of the error. The first UE 121, the processing circuitry 960, and/or the receiving unit 902 may further be configured to receive, from the first network node 141, the updated transcript of the audio input, wherein the first UE 121, and/or the processing circuitry 960 may be configured to display the updated transcript to the user of the first UE 121.

The first UE 121 further comprises a memory 970. The memory comprises one or more units to be used to store data on, such as indications, translations, transcripts, and/or applications to perform the methods disclosed herein when being executed, and similar.

The methods according to the embodiments described herein for the first UE 121 are implemented by means of e.g. a computer program product 980 or a computer program, comprising instructions, i.e., software code portions, which, when executed on at least one processor, cause the at least one processor to carry out the actions described herein, as performed by the first UE 121. The computer program 980 may be stored on a computer-readable storage medium 990, e.g. a disc or similar. The computer-readable storage medium 990, having stored thereon the computer program product, may comprise the instructions which, when executed on at least one processor, cause the at least one processor to carry out the actions described herein, as performed by the first UE 121. In some embodiments, the computer-readable storage medium may be a non-transitory computer-readable storage medium.

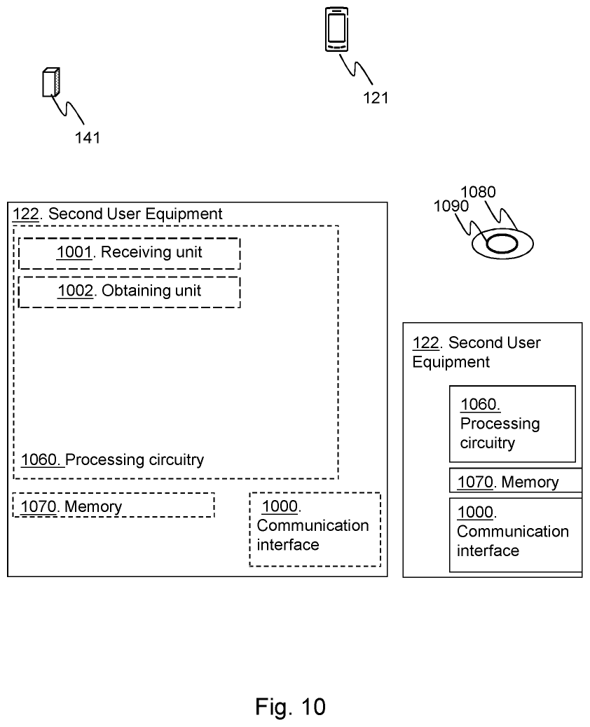

To perform the method actions above for handling translations of an ongoing media session between participants, the second UE 122 may comprise the arrangement depicted in FIG. 10.

FIG. 10 is a block diagram depicting the second UE 122 in two embodiments. The second UE 122 may be used for handling translations of an ongoing media session between participants, e.g. receiving translations of audio input in a media session. This second UE 122 may comprise a processing circuitry 1060 e.g. one or more processors, configured to perform the methods herein.

The second UE 122 may comprise a communication interface 1000 depicted in FIG. 10, configured to communicate e.g. with the first UE 121 and the first network node 141. The communication interface 1000 may comprise a transceiver, a receiver, a transmitter, and/or one or more antennas.

The second UE 122 may comprise a receiving unit 1001, e.g. a receiver, transceiver or retrieving module. The second UE 122, the processing circuitry 1060, and/or the receiving unit 1001 is configured to receive, from the first network node 141, the translation of the audio input of the media session between the participants. The translation may comprise one or more audio parts and/or one or more text lines.

The second UE 122, the processing circuitry 1060, and/or the receiving unit 1001 is further configured to receive, from the first network node 141, the indication of the error in the received translation of the media session between the participants.

The second UE 122 may comprise an obtaining unit 1002, e.g. a receiver, transceiver or retrieving module. The second UE 122, the processing circuitry 1060, and/or the obtaining unit 1002 may be configured to obtain from the first network node 141, the updated translation of the audio input of the media session between participants.

The second UE 122 further comprises a memory 1070. The memory comprises one or more units to be used to store data on, such as indications, translations, transcripts, and/or applications to perform the methods disclosed herein when being executed, and similar.

The methods according to the embodiments described herein for the second UE 122 are implemented by means of e.g. a computer program product 1080 or a computer program, comprising instructions, i.e., software code portions, which, when executed on at least one processor, cause the at least one processor to carry out the actions described herein, as performed by the second UE 122. The computer program 1080 may be stored on a computer-readable storage medium 1090, e.g. a disc or similar. The computer-readable storage medium 1090, having stored thereon the computer program product, may comprise the instructions which, when executed on at least one processor, cause the at least one processor to carry out the actions described herein, as performed by the second UE 122. In some embodiments, the computer-readable storage medium may be a non-transitory computer-readable storage medium.

As will be readily understood by those familiar with communications design, that functions, means, units, or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of an intermediate network node, for example.

Alternatively, several of the functional elements of the processing circuitry discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of radio network nodes will appreciate the cost, performance, and maintenance trade-offs inherent in these design choices.

In some embodiments a non-limiting term “UE” is used. The UE herein may be any type of UE capable of communicating with network node or another UE over radio signals. The UE may also be a radio communication device, target device, device to device (D2D) UE, machine type UE or UE capable of machine to machine communication (M2M), Internet of things (IoT) operable device, a sensor equipped with UE, iPad, Tablet, mobile terminals, smart phone, laptop embedded equipped (LEE), laptop mounted equipment (LME), USB dongles, Customer Premises Equipment (CPE) etc.

Also in some embodiments generic terminology “network node”, is used. It may be any kind of network node which may comprise of a core network node, e.g., NOC node, Mobility Managing Entity (MME), Operation and Maintenance (O&M) node, Self-Organizing Network (SON) node, a coordinating node, controlling node, Minimizing Drive Test (MDT) node, etc.), or an external node (e.g., 3^{rd} party node, a node external to the current network), or even a radio network node such as base station, radio base station, base transceiver station, base station controller, network controller, evolved Node B (eNB), Node B, multi-RAT base station, Multi-cell/multicast Coordination Entity (MCE), relay node, access point, radio access point, Remote Radio Unit (RRU) Remote Radio Head (RRH), etc.

The term “radio node” used herein may be used to denote the wireless device or the radio network node.

The term “signaling” used herein may comprise any of: high-layer signaling, e.g., via Radio Resource Control (RRC), lower-layer signaling, e.g., via a physical control channel or a broadcast channel, or a combination thereof. The signaling may be implicit or explicit. The signaling may further be unicast, multicast or broadcast. The signaling may also be directly to another node or via a third node.

The embodiments described herein may apply to any RAT or their evolution, e.g., LTE Frequency Duplex Division (FDD), LTE Time Duplex Division (TDD), LTE with frame structure 3 or unlicensed operation, UTRA, GSM, WiFi, short-range communication RAT, narrow band RAT, RAT for 5G, etc.

With reference to FIG. 11, in accordance with an embodiment, a communication system includes a telecommunication network 3210 such as the wireless communications network 100, e.g. a NR network, such as a 3GPP-type cellular network, which comprises an access network 3211, such as a radio access network, and a core network 3214. The access network 3211 comprises a plurality of base stations 3212a, 3212b, 3212c, such as the radio network node 110, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the wireless devices 120 such as a Non-AP STA 3291 located in coverage area 3213c is configured to wirelessly connect to, or be paged by, the corresponding base station 3212c. A second UE 3292 e.g. the first or second radio node 110, 120 or such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 11 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

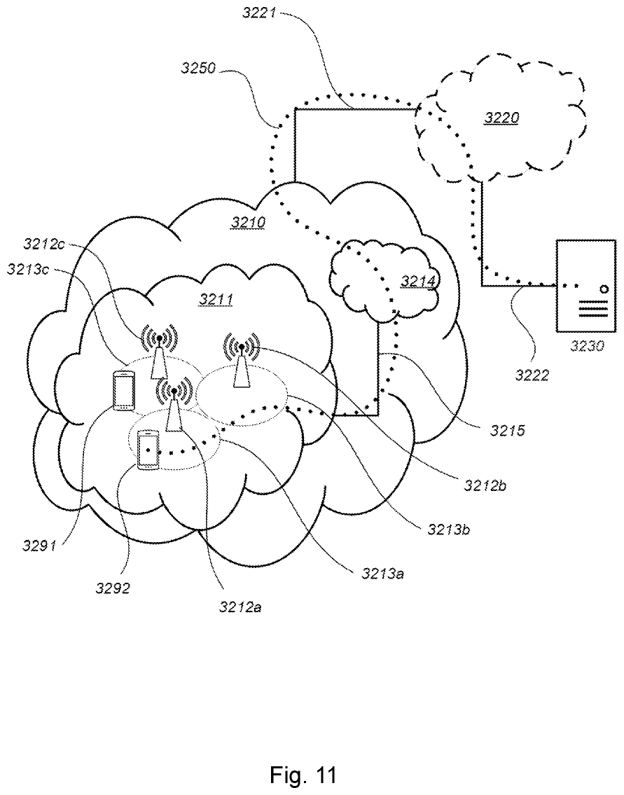

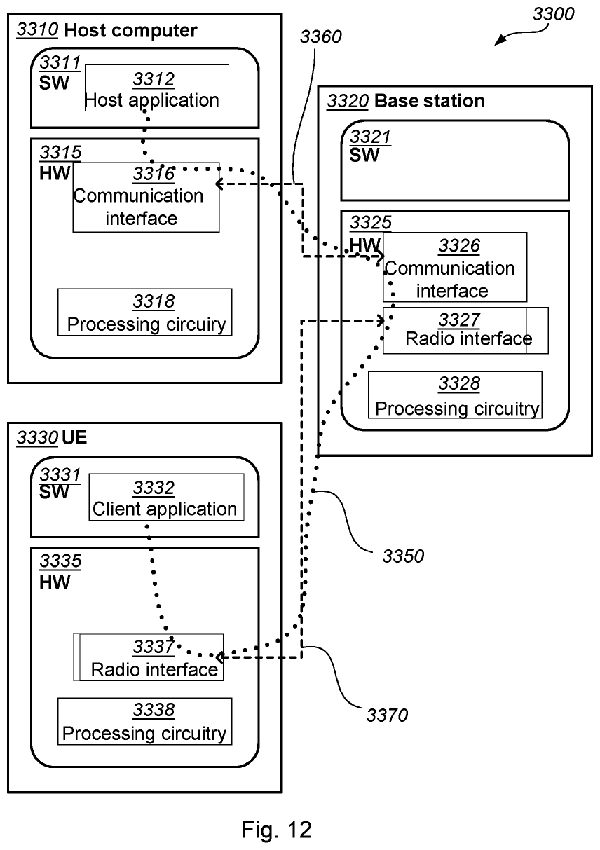

Example implementations, in accordance with an embodiment, of the UE, base station and host computer discussed in the preceding paragraphs will now be described with reference to FIG. 12. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 12) served by the base station 3320. The communication interface 3326 may be configured to facilitate a connection 3360 to the host computer 3310. The connection 3360 may be direct or it may pass through a core network (not shown in FIG. 12) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 12 may be identical to the host computer 3230, one of the base stations 3212a, 3212b, 3212c and one of the UEs 3291, 3292 of FIG. 11, respectively. This is to say, the inner workings of these entities may be as shown in FIG. 12 and independently, the surrounding network topology may be that of FIG. 11.

In FIG. 12, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the in-call translation services e.g. in terms of user friendliness, accuracy and reliability and thereby provide benefits such as improved user experience, efficiency of media sessions, cost effectiveness and so forth.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

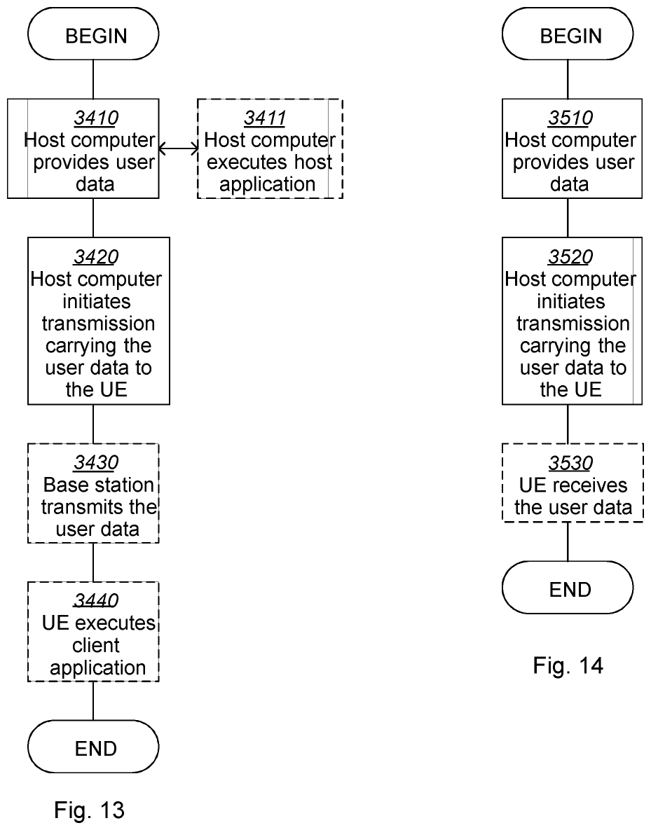

FIG. 13 is a flowchart illustrating a method implemented in a communication system, in accordance with one embodiment. The communication system includes a host computer, a base station such as an AP STA, and a UE such as a Non-AP STA which may be those described with reference to FIG. 11 and FIG. 12. For simplicity of the present disclosure, only drawing references to FIG. 13 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 14 is a flowchart illustrating a method implemented in a communication system, in accordance with one embodiment. The communication system includes a host computer, a base station such as an AP STA, and a UE such as a Non-AP STA which may be those described with reference to FIG. 11 and FIG. 12. For simplicity of the present disclosure, only drawing references to FIG. 14 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

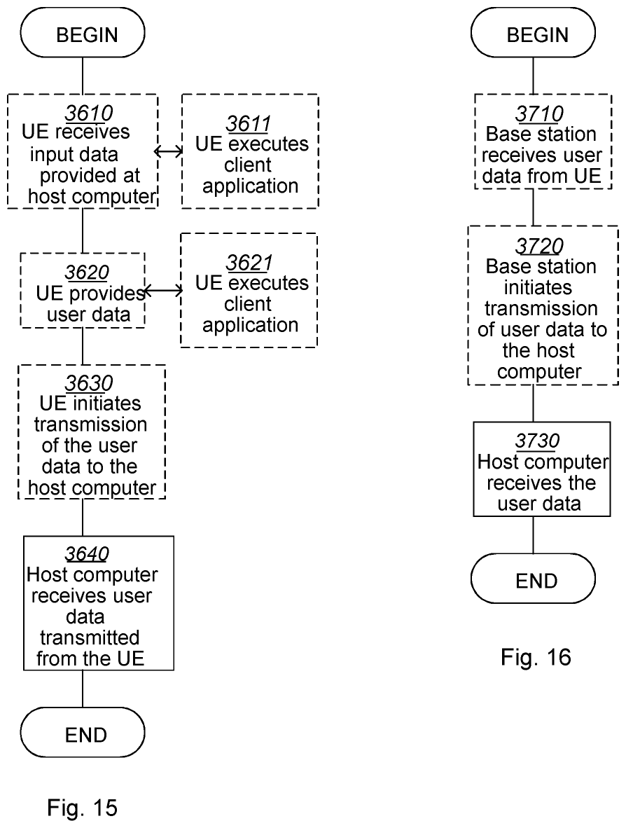

FIG. 15 is a flowchart illustrating a method implemented in a communication system, in accordance with one embodiment. The communication system includes a host computer, a base station such as an AP STA, and a UE such as a Non-AP STA which may be those described with reference to FIG. 11 and FIG. 12. For simplicity of the present disclosure, only drawing references to FIG. 15 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 16 is a flowchart illustrating a method implemented in a communication system, in accordance with one embodiment. The communication system includes a host computer, a base station such as an AP STA, and a UE such as a Non-AP STA which may be those described with reference to FIG. 11 and FIG. 12. For simplicity of the present disclosure, only drawing references to FIG. 16 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1-27. (canceled)

28. A method performed by a first User Equipment, UE, in a communications network, for handling translations of an ongoing media session between participants, the method comprising:
transmitting, to a first network node, an audio input from a user of the first UE;
receiving, from the first network node, a transcript of the audio input, wherein the transcript is displayed to the user of the first UE;
obtaining an input from the user of the first UE indicating an error in the transcript;
and in response to the obtained input transmitting, to the first network node, an indication of the error.

29. The method of claim 28, wherein the transcript is received as one or more text lines.

30. The method of claim 28, wherein the input from the user of the first UE comprises a voice command and/or a touch command.

31. The method of claim 28, further comprising obtaining, from the first network node, a first translation of the audio input from the user of the first UE and/or a second translation of an audio input from a second UE of another participant in the ongoing media session.

32. A method, performed by a second User Equipment (UE) in a communications network, for handling translations of an ongoing media session between participants, the method comprising:
receiving, from a first network node, a translation of an audio input of a media session between participants; and
receiving, from the first network node, an indication of an error in the received translation of the media session between the participants.

33. The method of claim 32, wherein the translation is received as one or more audio parts and/or one or more text lines.

34. A first User Equipment (UE) configured to handle translations of an ongoing media session between participants, the UE comprising:
processing circuitry;
memory containing instructions executable by the processing circuitry whereby the first UE is operative to:
transmit, to a first network node, an audio input from a user of the first UE;
receive, from the first network node, a transcript of the audio input, wherein the transcript is displayed to the user of the first UE;
obtain an input from the user of the first UE indicating an error in the transcript; and in response to the obtained input
transmit, to the first network node, an indication of the error.

35. The first UE of claim 34, wherein the transcript comprises one or more text lines.

36. The first UE of claim 34, wherein the input from the user of the first UE comprises a voice command and/or a touch command.

37. The first UE of claim 34, wherein the instructions are such that the first UE is operative to obtain, from the first network node, a first translation of the audio input from the user of the first UE and/or a second translation of an audio input from a second UE of another participant in the ongoing media session.

38. The first UE of claim 37, wherein the first and/or the second translation comprises one or more audio parts and/or one or more text lines.

39. A second User Equipment (UE) configured to handle translations of an ongoing media session between participants, the second UE comprising:
processing circuitry;
memory containing instructions executable by the processing circuitry whereby the second UE is operative to:
receive, from a first network node, a translation of an audio input of a media session between participants; and
receive, from the first network node, an indication of an error in the received translation of the media session between the participants.

40. The second UE of claim 39, wherein the translation comprises one or more audio parts and/or one or more text lines.
